(19) United States
(12) Patent Application Publication
(10) Pub. No.: US 2026/0184968 A1
(43) Pub. Date: Jul. 2, 2026

(54) COMPOSITE POLYESTER FILM AND PREPARATION METHOD THEREFOR AND USE THEREOF

(71) Applicant: Yangzhou Nanopore Innovative Materials Technology Ltd., Jiangsu (CN)

(72) Inventors: Zhongya Zhu, Jiangsu (CN); Shuai Wang, Jiangsu (CN); Jianzhong Xia, Jiangsu (CN); Xuefa Li, Jiangsu (CN); Guoping Zhang, Jiangsu (CN)

(73) Assignee: Yangzhou Nanopore Innovative Materials Technology Ltd., Jiangsu (CN)

(21) Appl. No.: 19/109,635

(22) PCT Filed: Sep. 7, 2023
(86) PCT No.: PCT/CN2023/117459

§ 371 Date: Mar. 7, 2025

(30) Foreign Application Priority Data
Sep. 7, 2022 (CN) 202211090734.4
Sep. 7, 2022 (WO) PCT/CN2022/117593

(51) Int. Cl. C09J 7/25; B32B 27/08; B32B 27/18; B32B 27/36; C09J 7/38; H01M 4/66

(52) U.S. Cl. CPC C09J 7/255; B32B 27/08; B32B 27/18; B32B 27/36; C09J 7/38; H01M 4/667; H01M 4/668; B32B 2250/244; B32B 2250/40; B32B 2264/1023; B32B 2270/00; B32B 2307/54; B32B 2457/10; C09J 2203/33; C09J 2301/124

(57) ABSTRACT

The present application relates to a composite polyester film and a preparation method therefor and a use thereof. The composite polyester film comprises: an intermediate layer, and a first outer layer and a second outer layer respectively located on two opposite surfaces of the intermediate layer; the intermediate layer comprises the following components in parts by mass: 96.0-99.4 parts of a polyester and 0.5-3 parts of an oxygen-containing functional group modified polyester; the first outer layer comprises the following components in parts by mass: 79.0-94.9 parts of the polyester and 5-20 parts of the oxygen-containing functional group modified polyester; and the second outer layer comprises the following components in parts by mass: 79.0-94.9 parts of the polyester and 5-20 parts of the oxygen-containing functional group modified polyester.

### TECHNICAL FIELD

The present application relates to the technical field of polymer materials, and in particular to a composite polyester film, a preparation method therefor and an application thereof.

### BACKGROUND

At present, the composite current collector based on the macromolecular polymer film has attracted much attention and been widely applied in the new energy industry. The macromolecular polymer film, as a base film layer of the composite current collector, has the characteristics of high tensile strength, soft texture, low thermal expansion coefficient, and thermal shrinkage, so that when the composite current collector is applied to the battery, the risk of short-circuit inside the battery can be reduced, and the risk of exothermicity, combustion, or explosion of the battery can be reduced, and the safety of the battery is enhanced. However, in the conventional preparation of the composite current collector using the polyester film as a base film, there are some problems: (1) the bonding strength between the polyester film and the conductive layer is weak, and the conductive layer is easy to detach during the preparation of the current collector, resulting in a low yield of composite current collectors; and (2) the mechanical properties are poor, and film breakage occurs easily during the preparation process.

### SUMMARY

In view of the background, it is necessary to provide a composite polyester film, a preparation method therefor, and an application thereof, wherein the composite polyester film has good surface adhesion, can improve the bonding strength between the polyester film and the conductive layer, and reduce the probability of the conductive layer detaching during the preparation of the current collector; the composite polyester film also has good mechanical properties, which can reduce the probability of film breakage during the preparation of the current collector, thus improving the yield of the composite current collector.

In a first aspect, the present application provides a composite polyester film, which comprises: an intermediate layer, and a first outer layer and a second outer layer which are located on two opposite surfaces of the intermediate layer, respectively;
the intermediate layer comprises the following components by mass:
96.0-99.4 parts of a polyester and 0.5-3 parts of an oxygen-containing group-modified polyester;
the first outer layer comprises the following components by mass:
79.0-94.9 parts of the polyester and 5-20 parts of the oxygen-containing group-modified polyester; and
the second outer layer comprises the following components by mass:
79.0-94.9 parts of the polyester and 5-20 parts of the oxygen-containing group-modified polyester.

In some embodiments, the oxygen-containing group-modified polyester comprises one or more of a pentaerythritol-modified polyester, a glycerol-modified polyester, a poly(tetramethylene ether glycol)-modified polyester, a pyromellitic dianhydride-modified polyester, a 2,5-furandicarboxylic acid-modified polyester, an hydroxyl-terminated hyperbranched polyester, or a hexadecyl-terminated hyperbranched polyester.

In one embodiment, the oxygen-containing group-modified polyester has an intrinsic viscosity of 0.600-0.750 dL/g.

In one embodiment, the oxygen-containing group-modified polyester has a molecular weight distribution of 1.7-2.5.

In one embodiment, a modified unit in the oxygen-containing group-modified polyester has a molar proportion of 5%-15%.

In some embodiments, the polyester comprises one or more of polyethylene terephthalate and a derivative thereof, poly(ethylene-2,6-naphthalene dicarboxylate) and a derivative thereof, poly(butylene terephthalate) and a derivative thereof, poly(1,4-cyclohexylene dimethylene terephthalate) and a derivative thereof, poly(ethylene terephthalate-1,4-cyclohexylene dimethylene terephthalate), poly(propylene-2,6-naphthalene dicarboxylate) and a derivative thereof, poly(propylene terephthalate) and a derivative thereof, poly(butylene-2,6-naphthalene dicarboxylate) and a derivative thereof, poly(butylene-2,5-furandicarboxylate) and a derivative thereof, poly(butylene adipate-co-terephthalate) and a derivative thereof, and a polyarylester and a derivative thereof.

In one embodiment, the polyester has an intrinsic viscosity of 0.600-0.800 dL/g.

In one embodiment, the polyester has a molecular weight distribution of 1.7-2.5.

In some embodiments, the intermediate layer further comprises 0.1-1 parts by mass of an additive.

In some embodiments, the first outer layer further comprises 0.1-1 parts by mass of an additive.

In some embodiments, the second outer layer further comprises 0.1-1 parts by mass of an additive.

In some embodiments, the additive comprises one or more of a slip agent, an antioxidant, an antistatic agent, or a nucleating agent.

In one embodiment, an average particle size of the additive is less than or equal to 30% of a thickness of a layer in which the additive is contained.

In one embodiment, a thickness ratio of the intermediate layer to the first outer layer to the second outer layer is (70-90):(5-15):(5-15).

In a second aspect, the present application provides a preparation method for a composite polyester film, which comprises:
subjecting 96.0-99.4 parts by mass of a polyester and 0.5-3 parts by mass of an oxygen-containing group-modified polyester to mixing and melting, extruding, and slicing to obtain an intermediate layer sheet;
subjecting 79.0-94.9 parts by mass of a polyester and 5-20 parts by mass of an oxygen-containing group-modified polyester to mixing and melting, extruding, and slicing to obtain a first outer layer sheet;
subjecting 79.0-94.9 parts by mass of a polyester and 5-20 parts by mass of an oxygen-containing group-modified polyester to mixing and melting, extruding, and slicing to obtain a second outer layer sheet;
subjecting the intermediate layer sheet, the first outer layer sheet, and the second outer layer sheet to melt co-extrusion to obtain a film sheet; and
stretching the film sheet.

In one embodiment, the stretching comprises transverse stretching and longitudinal stretching.

In one embodiment, the transverse stretching has a ratio of (3-4):1.

In one embodiment, the longitudinal stretching has a ratio of (3-5):1.

In some embodiments, after the stretching, the preparation method comprises: subjecting the film sheet to a heat treatment.

In a third aspect, the present application provides a composite current collector, which comprises: the composite polyester film as described in any one of the above embodiments and an conductive layer located on at least one surface of the composite polyester film.

In a fourth aspect, the present application further provides a battery, which comprises the composite current collector as described in any one of the above embodiments.

In a fifth aspect, the present application further provides an electronic product which comprises the battery as described above.

When a small amount of the oxygen-containing group-modified polyester is added to the polyester, because of the hydrogen bond easily forming between the oxygen-containing functional group of the modified polyester and the terminal carboxyl group of the polyester, and the interaction, the interaction and degree of order of the polyester chain can be increased, and the polyester can be induced to crystallization; hence, the crystallinity of the polyester is enhanced. When the content of the oxygen-containing group-modified polyester exceeds a certain range, due to the high content of the oxygen-containing group-modified polyester, the interaction between the oxygen-containing functional group and the terminal carboxyl group of the polyester is too strong, and the steric hindrance of the branched structure of the oxygen-containing group-modified polyester is more significant, which is not conducive to the regular orientation of the polyester, resulting in a decrease of the crystallinity.

The components of the above composite polyester film comprise the polyester and oxygen-containing group-modified polyester, and the structure of the composite polyester film has three layers: a first outer layer-an intermediate layer-a second outer layer. The polyester raw material of the surface layer has the oxygen-containing group-modified polyester co-blended in by an appropriate amount, the modification of oxygen-containing functional group can provide the polyester with branched structure and increase the content of oxygen-containing functional groups in the molecular chain of the polyester; therefore, the crystallization of polyester of the surface layer is inhibited, the free volume of polyester of the surface layer is increased, and the improvement of the free volume and surface tension of the polyester in the surface layer can promote the adhesion of the surface of the polyester film. In the intermediate layer, a small amount of the oxygen-containing group-modified polyester is co-blended; the oxygen-containing group-modified polyester can enhance the crystallinity and plasticity of the intermediate layer of the polyester film, and can enhance the mechanical properties of the polyester film.

The preparation method for the above composite polyester film employs the co-extrusion and stretching methods, and the functional material of oxygen-containing group-modified polyester is co-blended in the main polyester material of each layer. By adjusting the amount of functional material, the crystallinity and plasticity of the main material can be regulated, and by combining the corresponding film forming process, the polyester film with improved surface adhesion and mechanical properties can be prepared. The probability of the conductive layer detaching is reduced during the preparation of the collector, thus improving the yield of the composite current collector.

The composite current collector using the above composite polyester film as a support layer has an improved bonding strength between the support layer and the conductive layer, which can reduce the risk of the conductive layer detaching during the preparation and improve the yield rate.

### BRIEF DESCRIPTION OF DRAWINGS

In order to more clearly illustrate the technical solutions in embodiments of the present application or in the prior art, the accompanying drawings to be used in the description of the embodiments or the prior art will be briefly described below. Obviously, the accompanying drawings in the following description are only some embodiments of the present application, and for those skilled in the art, other accompanying drawings can be obtained based on these drawings without creative efforts.

FIG. 1 is a schematic structural diagram of the composite polyester film provided in an embodiment of the present application;

FIG. 2 is a preparation method flowchart of the composite polyester film provided in an embodiment of the present application;

FIG. 3 is a schematic diagram of the composite current collector provided in an embodiment of the present application.

Reference list: 1—first outer layer; 2—intermediate layer; 3—a second outer layer; 4—first protective layer; 5—first conductive layer; 6—composite polyester film; 7—second conductive layer; and 8—second protective layer.

### DETAILED DESCRIPTION

For a better understanding of the above objects, features and advantages of the present application, specific embodiments of the present application are described in detail below in conjunction with the accompanying drawings. Many specific details are described in the following description for the convenience in understanding the present application. However, the present application can be implemented in many other ways different from those described herein, and those skilled in the art can make similar improvements without violating the conception of the present application, so the present application is not limited by the specific embodiments disclosed below.

Unless otherwise defined, all technical terms and scientific terms used herein have the same meanings that are commonly understood by those skilled in the art of the present application. The terms used herein in the specification of the present application are used only for the object of describing specific embodiments but not intended to limit the present application. The term “and/or” as used herein comprises any and all combinations of one or more of the involved listed items.

In addition, the terms such as “first” and “second” are used only for descriptive purposes and cannot be understood as indicating or implying relative importance or implicitly specifying the number of technical features. Thus, features defined by “first” and “second” can explicitly or implicitly comprise one or more of the features. In the description of the present application, unless otherwise defined, “a plurality of” means two or more, such as two, three, etc.

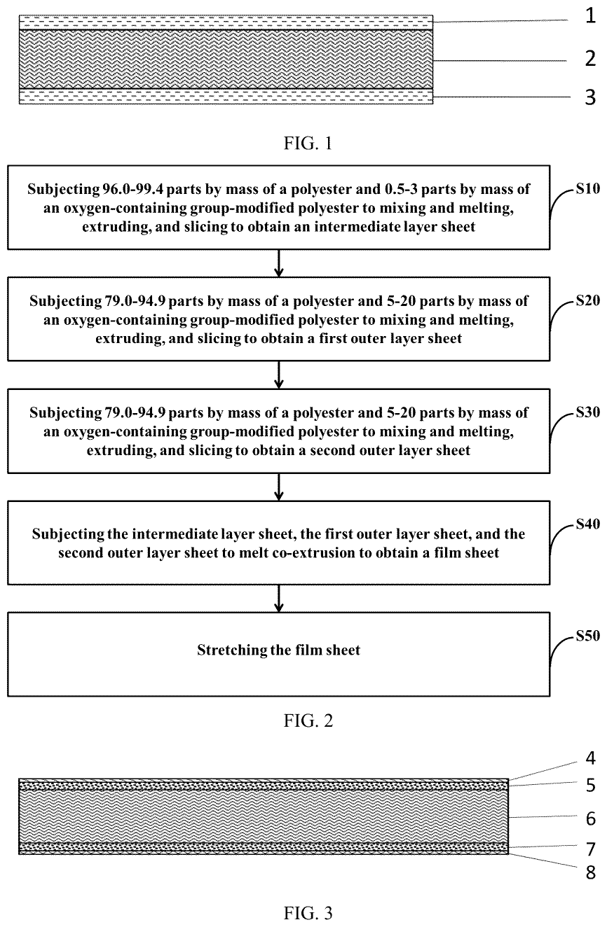

See FIG. 1; an embodiment of the present application provides a composite polyester film, comprising: an intermediate layer 2, and a first outer layer 1 and a second outer layer 3 which are located on two opposite surfaces of the intermediate layer, respectively;
the intermediate layer comprises the following components by mass:
96.0-99.4 parts of a polyester and 0.5-3 parts of an oxygen-containing group-modified polyester;
the first outer layer comprises the following components by mass:
79.0-94.9 parts of a polyester and 5-20 parts of an oxygen-containing group-modified polyester; and
the second outer layer comprises the following components by mass:
79.0-94.9 parts of a polyester and 5-20 parts of an oxygen-containing group-modified polyester.

The components of the composite polyester film comprise the polyester and oxygen-containing group-modified polyester, and the composite polyester film has a three-layer structure of a first outer layer-an intermediate layer-a second outer layer. In the polyester raw material of the outer layer, an appropriate amount of the oxygen-containing group-modified polyester and the additive are co-blended. When the oxygen-containing group-modified polyester is 5-20 parts by mass, the modification of oxygen-containing functional group can provide the polyester with branched structure and increase the content of oxygen-containing functional group in the molecular chain of the polyester. The high content of the branched structure increases the difficulty of the polyester regular arrangement, and meanwhile, with the increase of oxygen-containing functional group, the intermolecular force is strengthened, which also results in the increase of the difficulty of the macromolecule regular arrangement, so as to inhibit the crystallization of the polyester of the surface layer and increase the free volume of the polyester of the surface layer; the improvement of the free volume and surface tension of the polyester in the surface layer can make the surface of the polyester film have good adhesion. In the intermediate layer, a small amount of the oxygen-containing group-modified polyester is co-blended; when the oxygen-containing group-modified polyester is 0.5-3 parts by mass, the oxygen-containing group-modified polyester can enhance the crystallinity and plasticity of the intermediate layer of the polyester film, and also enhance the mechanical properties of the composite polyester film.

In one embodiment, the polyester or the oxygen-containing group-modified polyester in each layer may be the same or different.

In one embodiment, the oxygen-containing group-modified polyester comprises one or more of a pentaerythritol-modified polyester, a glycerol-modified polyester, a poly(tetramethylene ether glycol)-modified polyester, a pyromellitic dianhydride-modified polyester, a 2,5-furandicarboxylic acid-modified polyester, an hydroxyl-terminated hyperbranched polyester, or a hexadecyl-terminated hyperbranched polyester.

In one embodiment, the polyester comprises one or more of polyethylene terephthalate and a derivative thereof, poly(ethylene-2,6-naphthalene dicarboxylate) and a derivative thereof, poly(butylene terephthalate) and a derivative thereof, poly(1,4-cyclohexylene dimethylene terephthalate) and a derivative thereof, poly(ethylene terephthalate-1,4-cyclohexylene dimethylene terephthalate), poly(propylene-2,6-naphthalene dicarboxylate) and a derivative thereof, poly(propylene terephthalate) and a derivative thereof, poly(butylene-2,6-naphthalene dicarboxylate) and a derivative thereof, poly(butylene-2,5-furandicarboxylate) and a derivative thereof, poly(butylene adipate-co-terephthalate) and a derivative thereof, and a polyarylester and a derivative thereof.

In one embodiment, the oxygen-containing group-modified polyester has an intrinsic viscosity of 0.600-0.750 dL/g. Optionally, the oxygen-containing group-modified polyester has an intrinsic viscosity of 0.650-0.750 dL/g. Further optionally, the oxygen-containing group-modified polyester has an intrinsic viscosity of 0.650 dL/g, 0.670 dL/g, 0.690 dL/g, 0.710 dL/g, 0.730 dL/g, or 0.750 dL/g.

In one embodiment, the oxygen-containing group-modified polyester has a molecular weight distribution of 1.7-2.5. Optionally, the oxygen-containing group-modified polyester has a molecular weight distribution of 1.8-2.2. Further optionally, the oxygen-containing group-modified polyester has a molecular weight distribution of 1.8, 1.9, 2.0, 2.1, or 2.2.

In one embodiment, a modified unit in the oxygen-containing group-modified polyester has a molar proportion of 5%-15%. Optionally, the modified unit in the oxygen-containing group-modified polyester has a molar proportion of 8%-12%. Further optionally, the modified unit in the oxygen-containing group-modified polyester has a molar proportion of 8%, 9%, 10%, 11%, or 12%.

In one embodiment, the polyester has an intrinsic viscosity of 0.600-0.800 dL/g. When the intrinsic viscosity of the polyester is too low, the average molecular mass of the polyester film is low, and the mechanical properties of the prepared polyester film are poor; when the intrinsic viscosity of the polyester is too high, the average molecular mass of the polyester film is high, which causes poor film-forming performance and film breakage. Within the range of the intrinsic viscosity of the polyester, the prepared polyester film can have both good mechanical properties and good film-forming performance. Optionally, the polyester has an intrinsic viscosity of 0.650-0.750 dL/g. Further optionally, the polyester has an intrinsic viscosity of 0.650 dL/g, 0.670 dL/g, 0.690 dL/g, 0.710 dL/g, 0.730 dL/g, or 0.750 dL/g.

In one embodiment, the polyester has a molecular weight distribution of 1.7-2.5. When the molecular weight distribution of the polyester is too low, the film-forming performance will be poor; when the molecular weight distribution of the polyester is too high, the stability of the prepared polyester film will be poor. Within the range of the molecular weight distribution of the polyester, the prepared polyester film can have both good film-forming performance and stability. Optionally, the polyester has a molecular weight distribution of 1.9-2.3. Further optionally, the polyester has a molecular weight distribution of 1.9, 2.0, 2.1, 2.2, or 2.3.

In some embodiments, the intermediate layer further comprises 0.1-1 parts by mass of an additive.

In some embodiments, the first outer layer further comprises 0.1-1 parts by mass of an additive.

In some embodiments, the second outer layer further comprises 0.1-1 parts by mass of an additive.

In one embodiment, the intermediate layer further comprises 0.1-1 parts by mass of an additive; the first outer layer further comprises 0.1-1 parts by mass of an additive; the second outer layer further comprises 0.1-1 parts by mass of an additive.

In some embodiments, based on a total mass of the intermediate layer, the intermediate layer comprises the following components by mass percentage:
96.0%-99.4% of a polyester, 0.5%-3% of an oxygen-containing group-modified polyester, and 0.1%-1% of an additive;
based on a total mass of the first outer layer, the first outer layer comprises the following components by mass percentage:
79.0%-94.9% of a polyester, 5%-20% of an oxygen-containing group-modified polyester, and 0.1%-1% of an additive; and
based on a total mass of the second outer layer, the second outer layer comprises the following components by mass percentage:
79.0%-94.9% of a polyester, 5%-20% of an oxygen-containing group-modified polyester, and 0.1%-1% of an additive.

In one embodiment, based on a total mass of the intermediate layer, raw materials of the intermediate layer comprise the following components by mass percentage:
96.0%-99.4% of a polyester, 0.5%-3% of an oxygen-containing group-modified polyester, and 0.1%-1% of an additive;
based on a total mass of the first outer layer, raw materials of the first outer layer comprise the following components by mass percentage:
79.0%-94.9% of a polyester, 5%-20% of an oxygen-containing group-modified polyester, and 0.1%-1% of an additive;
based on a total mass of the second outer layer, raw materials of the second outer layer comprise the following components by mass percentage:
79.0%-94.9% of a polyester, 5%-20% of an oxygen-containing group-modified polyester, and 0.1%-1% of an additive.

In some embodiments, the additive comprises one or more of a slip agent, an antioxidant, an antistatic agent, or a nucleating agent.

In some embodiments, the slip agent comprises one or more of titanium dioxide, silicon dioxide, calcium carbonate, talc, kaolin, diatomaceous earth, siloxane, or acrylate;
the antioxidant comprises one or more of phosphonate or bisphenol A phosphite;
the antistatic agent comprises one or more of propanetriol, polyglycerol, polyethylene glycol, polyether ester, carbon black, graphite, or conductive fibers;
the nucleating agent comprises one or more of zinc oxide, aluminum oxide, magnesium oxide, copper oxide, barium sulfate, sodium carbonate, triphenyl phosphate, benzophenone, polycaprolactone, magnesium stearate, or sodium benzoate.

In one embodiment, an average particle size of the additive is 0.01-1.5 microns. When the average particle size of the additive is too small, the effect of promoting film formation and enhancing the polyester film performance is poor; when the average particle size of the additive is too large, defects are prone to be formed in the film preparation. Within the range of the average particle size of the additive, the polyester film can have good performance. Optionally, the average particle size of the additive is 0.01 microns, 0.05 microns, 0.1 microns, 0.3 microns, 0.5 microns, 0.7 microns, 1.0 microns, or 1.5 microns.

In one embodiment, an average particle size of the additive is less than or equal to 30% of a thickness of the layer in which the additive is contained. The average particle size of the additive being less than or equal to 30% of a thickness of the layer in which the additive is contained can reduce the film defects caused by the mismatch between the thickness of the layer in which the additive is located and the particle size of the additive.

In one embodiment, a thickness ratio of the intermediate layer to the first outer layer to the second outer layer is (70-90):(5-15):(5-15).

In one embodiment, a thickness of the composite polyester film is 2-20 microns. A smaller thickness of the polyester film gives a greater increase in the energy density of the composite current collector. A smaller thickness of the polyester film also results in a greater production difficulty and a lower yield. Within the thickness range of the polyester film, the composite current collector with a high energy density can be obtained and also the production difficulty and the yield rate are taken into account. Optionally, the thickness of the composite polyester film is 2 microns, 5 microns, 7 microns, 10 microns, 15 microns, or 20 microns.

See FIG. 2; an embodiment of the present application provides a preparation method for a composite polyester film, which comprises the following steps:
S10: subjecting 96.0-99.4 parts by mass of a polyester and 0.5-3 parts by mass of an oxygen-containing group-modified polyester to mixing and melting, extruding, and slicing to obtain an intermediate layer sheet;
S20: subjecting 79.0-94.9 parts by mass of a polyester and 5-20 parts by mass of an oxygen-containing group-modified polyester to mixing and melting, extruding, and slicing to obtain a first outer layer sheet;
S30: subjecting 79.0-94.9 parts by mass of a polyester and 5-20 parts by mass of an oxygen-containing group-modified polyester to mixing and melting, extruding, and slicing to obtain a second outer layer sheet;
S40: subjecting the intermediate layer sheet, the first outer layer sheet, and the second outer layer sheet to melt co-extrusion to obtain a film sheet; and
S50: stretching the film sheet.

In some embodiments, the preparation method for a composite polyester film comprises the following steps:
(1) subjecting 96.0-99.4 parts by mass of a polyester, 0.5-3 parts by mass of an oxygen-containing group-modified polyester, and 0.1-1 parts by mass of an additive to mixing and melting, extruding, and slicing to obtain an intermediate layer sheet;
(2) subjecting 79.0-94.9 parts by mass of a polyester, 5-20 parts by mass of an oxygen-containing group-modified polyester, and 0.1-1 parts by mass of an additive to mixing and melting, extruding, and slicing to obtain a first outer layer sheet;
(3) subjecting 79.0-94.9 parts by mass of a polyester, 5-20 parts by mass of an oxygen-containing group-modified polyester, and 0.1-1 parts by mass of an additive to mixing and melting, extruding, and slicing to obtain a second outer layer sheet;
(4) subjecting the intermediate layer sheet, the first outer layer sheet, and the second outer layer sheet to melt co-extrusion to obtain a film sheet; and
(5) stretching the film sheet.

In one embodiment, the preparation method for a composite polyester film comprises the following steps:
(1) based on a total mass of the intermediate layer, subjecting 96.0%-99.4% of a polyester, 0.5%-3% of an oxygen-containing group-modified polyester, and 0.1%-1% of an additive to mixing and melting, extruding, and slicing to obtain an intermediate layer sheet;
(2) based on a total mass of the first outer layer, subjecting 79.0%-94.9% of a polyester, 5%-20% of an oxygen-containing group-modified polyester, and 0.1%-1% of an additive to mixing and melting, extruding, and slicing to obtain a first outer layer sheet;
(3) based on a total mass of the second outer layer, subjecting 79.0%-94.9% of a polyester, 5%-20% of an oxygen-containing group-modified polyester, and 0.1%-1% of an additive to mixing and melting, extruding, and slicing to obtain a second outer layer sheet;
(4) subjecting the intermediate layer sheet, the first outer layer sheet, and the second outer layer sheet to melt co-extrusion to obtain a film sheet; and
(5) stretching the film sheet.

In one embodiment, the stretching comprises transverse stretching and longitudinal stretching. Optionally, the stretching comprises transverse stretching and longitudinal stretching which are performed in sequence, or the stretching comprises longitudinal stretching and transverse stretching which are performed in sequence.

In one embodiment, the transverse stretching has a ratio of (3-4):1.

In one embodiment, the longitudinal stretching has a ratio of (3-5):1.

In one embodiment, the longitudinal stretching comprises the following steps:
(1) preheating: preheating the formed film sheet before stretching at a preheating temperature of 70-100° C.;
(2) stretching: after the film sheet is preheated, performing longitudinal stretching with a stretching ratio of (3-5):1 at a stretching temperature of 80-120° C.;
(3) heat-setting: subjecting the film sheet obtained after the longitudinal stretching to heat-setting at a heat-setting temperature of 165-180° C.; and
(4) cooling: after the film sheet is subjected to the heat-setting, cooling at a cooling temperature of 30-50° C.

In one embodiment, the transverse stretching comprises the following steps:
(1) preheating: preheating the formed film sheet before transverse stretching at a preheating temperature of 80-120° C.;
(2) stretching: after the film sheet is preheated, performing transverse stretching with a stretching ratio of (3-4):1 at a stretching temperature of 90-140° C.;
(3) heat-setting: subjecting the film sheet obtained after the transverse stretching to heat-setting at a heat-setting temperature of 150-250° C.; and
(4) cooling: after the film sheet is subjected to the heat-setting, cooling at a cooling temperature of 80-150° C.

In one embodiment, before the melt co-extrusion of the intermediate layer sheet, the first outer layer sheet, and the second outer layer sheet, the preparation method further comprises: subjecting the intermediate layer sheet, the first outer layer sheet, and the second outer layer sheet to crystallization individually. The crystallization of sheets improves the crystallinity of the polyester and reduces the adhesion between sheets during the drying process.

In one embodiment, the crystallization is performed at a temperature of 130-185° C. for a period of 20-130 min. Optionally, the crystallization is performed at a temperature of 130° C., 140° C., 150° C., 160° C., 170° C., or 185° C.; the crystallization is performed for a period of 20 min, 30 min, 40 min, 50 min, 70 min, 90 min, 110 min, or 130 min.

In one embodiment, before the melt co-extrusion of the intermediate layer sheet, the first outer layer sheet, and the second outer layer sheet, the preparation method further comprises: drying the intermediate layer sheet, the first outer layer sheet, and the second outer layer sheet individually. The sheets are dried to remove moisture of the raw materials to reduce oxidation of the polyester during the subsequent melting and extruding process.

In one embodiment, the drying is performed at a temperature of 130-175° C. for a period of 110-300 min. Optionally, the drying is performed at a temperature of 130° C., 140° C., 150° C., 160° C., or 175° C.; the drying is performed for a period of 110 min, 130 min, 150 min, 170 min, 200 min, 220 min, 250 min, or 300 min.

In one embodiment, after the stretching, the preparation method further comprises: subjecting the film sheet to a heat treatment.

In one embodiment, the heat treatment comprises a first heat treatment, a second heat treatment, and a third heat treatment which are performed in sequence.

In one embodiment, the first heat treatment is performed at a temperature of 130-160° C. for a period of 0.5-2 min; the second heat treatment is performed at a temperature of 160-220° C. for a period of 0.5-5 min; the second heat treatment is performed at a temperature of 70-100° C. for a period of 0.5-2 min. The heat treatment can reduce the residual stress in the film sheet and improve the crystallinity of the film sheet moderately, thus reducing the thermal shrinkage rate of the film sheet and increasing the tensile strength of the film sheet. Optionally, the first heat treatment is performed at a temperature of 130° C., 140° C., 150° C., or 160° C.; the first heat treatment is performed for a period of 0.5 min, 0.7 min, 1 min, 1.2 min, 1.5 min, 1.7 min, or 2 min; the second heat treatment is performed at a temperature of 160° C., 170° C., 180° C., 190° C., 200° C., 210° C., or 220° C.; the second heat treatment is performed for a period of 0.5 min, 0.7 min, 1 min, 1.5 min, 2 min, 2.5 min, 3 min, 4 min, or 5 min; the third heat treatment is performed at a temperature of 70° C., 80° C., 90° C., or 100° C.; the third heat treatment is performed for a period of 0.5 min, 0.7 min, 1 min, 1.2 min, 1.5 min, 1.7 min, or 2 min.

An embodiment of the present application provides a composite current collector, which comprises: the composite polyester film as described in any one of the above embodiments and an conductive layer located on at least one surface of the composite polyester film.

In one embodiment, the composite current collector further comprises a protective layer, and the protective layer is located on a surface of the conductive layer away from the flexible polyester film.

In one embodiment, a thickness of the conductive layer is 500-2000 nm. Optionally, the thickness of the conductive layer is 700-1200 nm. Further optionally, the thickness of the conductive layer is 700 nm, 800 nm, 900 nm, 1000 nm, 1100 nm, or 1200 nm.

In one embodiment, a thickness of the protective layer is 10-150 nm. Optionally, the thickness of the protective layer is 10 nm, 30 nm, 50 nm, 70 nm, 100 nm, 120 nm, or 150 nm.

In one embodiment, a thickness of the protective layer is less than or equal to 10% of a thickness of the conductive layer. Optionally, the thickness of the protective layer is 1%, 3%, 5%, 7%, or 10% of the thickness of the conductive layer.

In one embodiment, (see FIG. 3), the composite current collector comprises: a composite polyester film 6, a first conductive layer 5 and a second conductive layer 7 which are located on two opposite surfaces of the composite polyester film, respectively, a first protective layer 4 which is located on the surface of the first conductive layer away from the composite polyester film, and a second protective layer 8 which is located on the surface of the second conductive layer away from the composite polyester film.

In one embodiment, a material of the conductive layer is selected from one or more of copper, a copper alloy, aluminum, an aluminum alloy, nickel, a nickel alloy, titanium, or silver.

In one embodiment, the conductive layer is prepared by one or more of a physical vapor deposition method, an electroplating method, or a chemical plating method. Optionally, the physical vapor deposition method comprises: resistance heating vacuum deposition, electron beam heating vacuum deposition, laser heating vacuum deposition, or magnetron sputtering.

In one embodiment, a material of the protective layer is selected from one or more of nickel, chromium, a nickel-based alloy, a copper-based alloy, copper oxide, aluminum oxide, nickel oxide, chromium oxide, cobalt oxide, graphite, carbon black, acetylene black, Ketjen black, carbon nano-quantum dots, carbon nanotubes, carbon nanofibers, or graphene.

In one embodiment, a preparation method for the protective layer is one or more of physical vapor deposition, chemical vapor deposition, in-situ forming, and coating. Optionally, the physical vapor deposition is selected from vacuum evaporation or magnetron sputtering; the chemical vapor deposition is selected from atmospheric pressure chemical vapor deposition or plasma-enhanced chemical vapor deposition; the in-situ forming is selected from a method of forming a metal oxide passivation layer in-situ on the surface of the conductive layer; and the coating method is selected from die coating, blade coating, or extrusion coating.

An embodiment of the present application provides a battery which comprises the composite current collector as described in any one of the above embodiments.

An embodiment of the present application provides an electronic product which comprises the battery as described above.

The following are specific examples.

### Example 1

Material selection in this example: the selected polyester is polyethylene terephthalate (PET) with an intrinsic viscosity of 0.675 dL/g and a molecular weight distribution of 2.2; the oxygen-containing group-modified polyester is pentaerythritol-modified polyethylene terephthalate (PENTA-PET) wherein a molar ratio of the modified unit is 10%, and an intrinsic viscosity is 0.645 dL/g; and the additives are antioxidant 300 and aluminum oxide with an average particle size of 0.2 microns.

A preparation method for the pentaerythritol-modified polyethylene terephthalate is:

1500 g of terephthalic acid, 900 g of ethylene glycol, 0.8 g of antimony ethylene glycolate (catalyst), and 140 g of pentaerythritol were added into a 5 L reactor, and then heated to 220° C., pressurized to 0.3 MPa, and reacted for 5 h; then polycondensation was performed at 260° C. and 200 Pa for 20 min, and after the polycondensation was completed, high-vacuum polycondensation was performed at 260° C. and 30 Pa for 1 h, and after the reaction was completed, the reactor was restored to positive pressure with nitrogen, and the material was discharged by opening the discharge valve, cooled, and cut into particles to obtain the PET particles modified by pentaerythritol copolymerization.

A preparation method for the composite polyester film is:
(1) PET, PENTA-PET, and an additive were heated, melted, mixed, extruded, molded, and sliced to prepare an intermediate layer sheet, a first outer layer sheet, and a second outer layer sheet, wherein the mass percentages of PET, PENTA-PET, antioxidant 300, and aluminum oxide in the first outer layer sheet were 94%, 5.0%, 0.5%, and 0.5%, respectively; the mass percentages of PET, PENTA-PET, antioxidant 300, and aluminum oxide in the second outer layer sheet were 94%, 5.0%, 0.5%, and 0.5%, respectively; the mass percentages of PET, PENTA-PET, antioxidant 300, and aluminum oxide in the intermediate layer sheet were 98.5%, 0.5%, 0.5%, and 0.5%;
(2) the intermediate layer sheet, the first outer layer sheet, and the second outer layer sheet were transported to a crystallizer and crystallized at 150° C. for 40 min; the intermediate layer sheet, the first outer layer sheet and the second outer layer sheet after the crystallization were transported to a drying tower and dried at 155° C. for 140 min;
(3) the dried intermediate layer sheet, first outer layer sheet, and second outer layer sheet were added to a twin-screw extruder, heated, and melted at 280° C., and extruded through the die head via a metering pump wherein extrusion amounts of the three layers were controlled at a ratio of 10%:80%:10%;
(4) the molten material extruded from the die head was cast onto a sheet-forming roller, and cooled with the sheet-forming roller and water cooling to be molded, and formed a sheet with a thickness of 54 microns;
(5) the sheet obtained in step (4) was sequentially preheated at 90° C., longitudinally stretched at 110° C. with a stretching ratio of 3:1, subjected to heat-setting at 170° C., and cooled and molded at 40° C.;
(6) the longitudinally stretched film sheet obtained in step (5) was sequentially preheated at 90° C., transversely stretched at 120° C. with a stretching ratio of 3:1, subjected to heat-setting at 170° C., and cooled and molded at 110° C.;
(7) the bi-directionally stretched film sheet was subjected to heat treatment; the specific process was a first heat treatment with a temperature of 140° C. for a period of 0.5 min, a second heat treatment with a temperature of 170° C. for a period of 0.5 min, and a third heat treatment with a temperature of 80° C. for a period of 0.5 min, which were performed in sequence; and

(8) the heat-treated film sheet was cooled through the platform area, and then sent to the winding system through the traction system to wind the film sheet, and a composite polyester film with a thickness of 6 microns was prepared.

The preparation method for the composite current collector in this example is:
(1) preparing conductive layer: the composite polyester film prepared above of which the surface was cleaned was placed in a chamber for vacuum evaporation, and a high-purity aluminum wire (with a purity of greater than 99.99%) in a metal evaporation chamber was melted and evaporated at a high temperature of 1300-2000° C.; the temperature in this example was 1500° C.; and the evaporated metal atoms passed through a cooling system inside the vacuum plating chamber and were deposited on two opposite surfaces of the composite polyester film to form aluminum conductive layers of 1 micron thickness; and
(2) preparing protective layer: 1 g of carbon nanotubes was uniformly dispersed into 999 g of N-methyl pyrrolidone (NMP) solution by ultrasonic dispersion to prepare a coating solution with a solid content of 0.1 wt. %; the coating solution was uniformly coated onto the surface of the conductive layer by die coating, where a coating amount was controlled to be 80 μm; and the coating was dried at 100° C.

### Example 2

Example 2 is basically the same as Example 1 except that the mass percentages of PET, PENTA-PET, antioxidant 300, and aluminum oxide in the first outer layer sheet and the second outer layer sheet are 89.0%, 10.0%, 0.5%, and 0.5%, respectively.

### Example 3

Example 3 is basically the same as Example 1 except that the mass percentages of PET, PENTA-PET, antioxidant 300, and aluminum oxide in the first outer layer sheet and the second outer layer sheet are 84.0%, 15.0%, 0.5%, and 0.5%, respectively.

### Example 4

Example 4 is basically the same as Example 3 except that the mass percentages of PET, PENTA-PET, antioxidant 300, and aluminum oxide in the first outer layer sheet and the second outer layer sheet are 79.0%, 20.0%, 0.5%, and 0.5%, respectively.

### Example 5

Example 5 is basically the same as Example 3 except that the mass percentages of PET, PENTA-PET, antioxidant 300, and aluminum oxide in the intermediate layer sheet are 98.0%, 1.0%, 0.5%, and 0.5%, respectively.

### Example 6

Example 6 is basically the same as Example 3 except that the mass percentages of PET, PENTA-PET, antioxidant 300, and aluminum oxide in the intermediate layer sheet are 97.0%, 2.0%, 0.5%, and 0.5%, respectively.

### Example 7

Example 7 is basically the same as Example 3 except that the mass percentages of PET, PENTA-PET, antioxidant 300, and aluminum oxide in the intermediate layer sheet are 96.0%, 3.0%, 0.5%, and 0.5%, respectively.

### Example 8

Example 8 is basically the same as Example 5 except that the longitudinal stretching ratio is 4:1.

### Example 9

Example 9 is basically the same as Example 5 except that the longitudinal stretching ratio is 5:1.

### Example 10

Example 10 is basically the same as Example 8 except that the transverse stretching ratio is 3.5:1.

### Example 11

Example 11 is basically the same as Example 8 except that the transverse stretching ratio is 4:1.

### Example 12

Example 12 is basically the same as Example 10 except that PENTA-PET was replaced with poly(tetramethylene ether glycol) (PTMG)-modified PET. A preparation method for the poly(tetramethylene ether glycol) (PTMG)-modified PET is: 1500 g of terephthalic acid, 780 g of ethylene glycol, 120 g of poly(tetramethylene ether glycol), and 1.0 g of antimony ethylene glycolate (catalyst) were added into a 5 L melt polycondensation reactor, and then heated to 230° C., pressurized to 0.4 MPa, and reacted for 5 h; then the polycondensation was performed at 260° C. and 200 Pa for 30 min, and after the polycondensation was completed, the high-vacuum polycondensation was performed at 260° C. and 30 Pa for 3 h, and after the reaction was completed, the reactor was restored to positive pressure with nitrogen, and the material was discharged by opening the discharge valve, cooled, and cut into particles to obtain the poly(tetramethylene ether glycol)-modified co-polyester particles.

### Example 13

Example 13 is basically the same as Example 10 except that PENTA-PET was replaced with 2,5-furandicarboxylic acid (FDCA)-modified PET. A preparation method for the 2,5-furandicarboxylic acid (FDCA)-modified PET is: 1500 g of terephthalic acid, 780 g of ethylene glycol, 120 g of poly(tetramethylene ether glycol), and 1.0 g of antimony ethylene glycolate (catalyst) were added into a 5 L melt polycondensation reactor, and then heated to 230° C., pressurized to 0.4 MPa, and reacted for 5 h; then the polycondensation was performed at 260° C. and 200 Pa for 30 min, and after the polycondensation was completed, the high-vacuum polycondensation was performed at 260° C. and 30 Pa for 3 h, and after the reaction was completed, the reactor was restored to positive pressure with nitrogen, and the material was discharged by opening the discharge valve, cooled, and cut into particles to obtain the poly(tetramethylene ether glycol)-modified co-polyester particles.

### Example 14

Example 14 is basically the same as Example 10 except that PENTA-PET was replaced with hydroxyl-terminated hyperbranched polyester (HBP-OH). A preparation method for the hydroxyl-terminated hyperbranched polyester (HBP-OH) is: 800 g of 2,2-bis(hydroxymethyl)propionic acid, 270 g of trimethylolpropane, and 3 g of p-toluenesulfonic acid (catalyst) were added into a 5 L three-necked flask, and then heated to 140° C. by the oil bath for the dehydration and refluxing reaction for 3 h, and then added with 1600 g of 2,2-dimethylpropionic acid and 1.6 g of p-toluenesulfonic acid, and the reaction was continued for 3 h. After the completion of the reaction, the introduction of nitrogen was stopped, and the water was removed by depressurization with a vacuum pump at 140° C. for 3 h. Subsequently, the product was cooled to room temperature, dissolved in an appropriate amount of acetone, recrystallized with toluene, filtered and dried to obtain the purified hydroxyl-terminated hyperbranched polyester.

### Comparative Example 1

Comparative Example 1 is basically the same as Example 1 except that the mass percentages of PET, PENTA-PET, antioxidant 300, and aluminum oxide in the intermediate layer sheet are 99.0%, 0%, 0.5%, and 0.5%, respectively; the mass percentages of PET, PENTA-PET, antioxidant 300, and aluminum oxide in the first outer layer sheet and the second outer layer sheet are 99.0%, 0%, 0.5%, and 0.5%, respectively.

### Comparative Example 2

Comparative Example 2 is basically the same as Example 1 except that the mass percentages of PET, PENTA-PET, antioxidant 300, and aluminum oxide in the first outer layer sheet and the second outer layer sheet are 76.0%, 23%, 0.5%, and 0.5%, respectively.

### Comparative Example 3

Comparative Example 3 is basically the same as Example 1 except that the mass percentages of PET, PENTA-PET, antioxidant 300, and aluminum oxide in the first outer layer sheet and the second outer layer sheet are 96.0%, 3%, 0.5%, and 0.5%, respectively.

### Comparative Example 4

Comparative Example 4 is basically the same as Example 1 except that the mass percentages of PET, PENTA-PET, antioxidant 300, and aluminum oxide in the intermediate layer sheet are 98.7%, 0.3%, 0.5%, and 0.5%, respectively.

### Comparative Example 5

Comparative Example 5 is basically the same as Example 1 except that the mass percentages of PET, PENTA-PET, antioxidant 300, and aluminum oxide in the intermediate layer sheet are 94.0%, 5%, 0.5%, and 0.5%, respectively.

### Comparative Example 6

Comparative Example 6 is basically the same as Example 1 except that the longitudinal stretching ratio is 2:1.

### Comparative Example 7

Comparative Example 7 is basically the same as Example 1 except that the transverse stretching ratio is 2:1.

The process parameters such as the mass percentage of each component of the outer layer, the mass percentage of each component of the intermediate layer, the longitudinal stretching ratio, and the transverse stretching ratio for the multilayer polyester film in Examples 1-14 and Comparative Examples 1-7 are shown in Table 1 below; because the first outer layer is identical to the corresponding second outer layer in each example and comparative example, they are hereinafter referred to as outer layers:

TABLE 1

| | Intermediate layer | | | | Outer layer | | | | | |
|---|---|---|---|---|---|---|---|---|---|---|
| | PET | PENTA- | Antioxidant | Aluminum | PET | PENTA- | Antioxidant | Aluminum | Stretching ratio | |
| No. | (%) | PET (%) | 300 (%) | oxide (%) | (%) | PET (%) | 300 (%) | oxide (%) | Longitudinal | Transverse |
| Example 1 | 98.5 | 0.5 | 0.5 | 0.5 | 94 | 5.0 | 0.5 | 0.5 | 3:1 | 3:1 |
| Example 2 | 98.5 | 0.5 | 0.5 | 0.5 | 89.0 | 10.0 | 0.5 | 0.5 | 3:1 | 3:1 |
| Example 3 | 98.5 | 0.5 | 0.5 | 0.5 | 84.0 | 15.0 | 0.5 | 0.5 | 3:1 | 3:1 |
| Example 4 | 98.5 | 0.5 | 0.5 | 0.5 | 79.0 | 20.0 | 0.5 | 0.5 | 3:1 | 3:1 |
| Example 5 | 98.0 | 1.0 | 0.5 | 0.5 | 84.0 | 15.0 | 0.5 | 0.5 | 3:1 | 3:1 |
| Example 6 | 97.0 | 2.0 | 0.5 | 0.5 | 84.0 | 15.0 | 0.5 | 0.5 | 3:1 | 3:1 |
| Example 7 | 96.0 | 3.0 | 0.5 | 0.5 | 84.0 | 15.0 | 0.5 | 0.5 | 3:1 | 3:1 |
| Example 8 | 98.0 | 1.0 | 0.5 | 0.5 | 84.0 | 15.0 | 0.5 | 0.5 | 4:1 | 3:1 |
| Example 9 | 98.0 | 1.0 | 0.5 | 0.5 | 84.0 | 15.0 | 0.5 | 0.5 | 5:1 | 3:1 |
| Example 10 | 98.0 | 1.0 | 0.5 | 0.5 | 84.0 | 15.0 | 0.5 | 0.5 | 4:1 | 3.5:1 |
| Example 11 | 98.0 | 1.0 | 0.5 | 0.5 | 84.0 | 15.0 | 0.5 | 0.5 | 4:1 | 4:1 |
| Example 12 | 98.0 | 1.0 | 0.5 | 0.5 | 84.0 | 15.0 | 0.5 | 0.5 | 4:1 | 3.5:1 |
| | | (PTMG-PET) | | | | (PTMG-PET) | | | | |
| Example 13 | 98.0 | 1.0 | 0.5 | 0.5 | 84.0 | 15.0 | 0.5 | 0.5 | 4:1 | 3.5:1 |
| | | (FDCA-PET) | | | | (FDCA-PET) | | | | |
| Example 14 | 98.0 | 1.0 | 0.5 | 0.5 | 84.0 | 15.0 | 0.5 | 0.5 | 4:1 | 3.5:1 |
| | | (HBP-OH) | | | | (HBP-OH) | | | | |
| Comparative | 99.0 | 0 | 0.5 | 0.5 | 99.0 | 0 | 0 | 0.5 | 3:1 | 3:1 |
| Example 1 | | | | | | | | | | |
| Comparative | 98.5 | 0.5 | 0.5 | 0.5 | 76.0 | 23.0 | 0.5 | 0.5 | 3:1 | 3:1 |
| Example 2 | | | | | | | | | | |
| Comparative | 98.5 | 0.5 | 0.5 | 0.5 | 96.0 | 3.0 | 0.5 | 0.5 | 3:1 | 3:1 |
| Example 3 | | | | | | | | | | |
| Comparative | 98.7 | 0.3 | 0.5 | 0.5 | 94 | 5.0 | 0.5 | 0.5 | 3:1 | 3:1 |
| Example 4 | | | | | | | | | | |
| Comparative | 94.0 | 5.0 | 0.5 | 0.5 | 94 | 5.0 | 0.5 | 0.5 | 3:1 | 3:1 |
| Example 5 | | | | | | | | | | |
| Comparative | 98.5 | 0.5 | 0.5 | 0.5 | 94 | 5.0 | 0.5 | 0.5 | 2:1 | 3:1 |
| Example 6 | | | | | | | | | | |
| Comparative | 98.5 | 0.5 | 0.5 | 0.5 | 94 | 5.0 | 0.5 | 0.5 | 3:1 | 2:1 |
| Example 7 | | | | | | | | | | |

The factors affecting the surface adhesion property of the polyester film in the composite polyester film prepared in Examples 1-14 and Comparative Examples 1-7 are tested and characterized, including: the free volume of the outer layer, the tensile strength and elongation at break characterizing the mechanical properties of the polyester film and the composite current collector, and the bonding strength of the polyester film and the conductive layer in the composite current collector, and the specific test methods are as follows.

(1) Free volume of the surface layer of the polyester film: the outer layer was peeled off from the prepared composite polyester film, and then the free volume of the surface polyester layer at room temperature was characterized by using positron annihilation lifetime spectroscopy (PALS).

(2) Tensile strength and elongation at break of the polyester film and the composite current collector: the test refers to the national standard GB/T 1040.3-2006.

(3) Bonding strength of the polyester film and conductive layer in the composite current collector: a layer of Permacel P-94 double-sided adhesive was bonded on an aluminum foil with a thickness of 1 mm, the composite current collector was bonded on the double-sided adhesive, and a layer of vinyl acrylic copolymer film (DuPont Nurcel0903, with a thickness of 50 μm) was covered on the composite current collector, and then hot-pressed at 1.3×10⁵ N/m² and 120° C. for 10 s, cooled to room temperature, and cut into small strips of 150 mm×15 mm. Finally, the small sample strip of ethylene acrylic copolymer film was fixed in the upper fixture of the tensile machine, and the rest part was fixed in the lower fixture, and after fixation, those two were peeled off at an angle of 180° and a speed of 100 mm/min to test the peeling force, i.e., the bonding strength between the polyester film and the conductive layer, wherein MD refers to the longitudinal direction, TD refers to the transverse direction, and the test results of the composite polyester film are shown in Table 2 below.

TABLE 2

| | Tensile | | Elongation at | | Fractional |
|---|---|---|---|---|---|
| | strength (MPa) | | break (%) | | free volume |
| No. | MD | TD | MD | TD | Outer layer |
| Example 1 | 296 | 275 | 100 | 108 | 0.025 |
| Example 2 | 295 | 275 | 101 | 108 | 0.032 |
| Example 3 | 293 | 274 | 103 | 107 | 0.041 |
| Example 4 | 292 | 273 | 105 | 110 | 0.035 |
| Example 5 | 335 | 306 | 95 | 105 | 0.041 |
| Example 6 | 321 | 288 | 97 | 106 | 0.041 |
| Example 7 | 308 | 277 | 99 | 107 | 0.041 |
| Example 8 | 369 | 305 | 90 | 104 | 0.040 |
| Example 9 | 398 | 299 | 80 | 105 | 0.038 |
| Example 10 | 365 | 345 | 91 | 95 | 0.037 |
| Example 11 | 359 | 356 | 93 | 91 | 0.036 |
| Example 12 | 346 | 320 | 94 | 102 | 0.039 |
| Example 13 | 377 | 353 | 88 | 92 | 0.035 |
| Example 14 | 353 | 328 | 92 | 97 | 0.043 |
| Comparative | 235 | 236 | 115 | 119 | 0.019 |
| Example 1 | | | | | |
| Comparative | 246 | 239 | 113 | 116 | 0.021 |
| Example 2 | | | | | |
| Comparative | 255 | 246 | 111 | 113 | 0.02 |
| Example 3 | | | | | |
| Comparative | 240 | 231 | 114 | 117 | 0.025 |
| Example 4 | | | | | |
| Comparative | 251 | 240 | 113 | 115 | 0.025 |
| Example 5 | | | | | |
| Comparative | 218 | 277 | 121 | 107 | 0.027 |
| Example 6 | | | | | |
| Comparative | 298 | 210 | 99 | 125 | 0.026 |
| Example 7 | | | | | |

The test results for the composite collector are shown in Table 3 below:

TABLE 3

| | | Bonding | | | | |
|---|---|---|---|---|---|---|
| | | strength | | | | |
| | | (N/cm) | | | | |
| | | Polyester | Tensile | | Elongation | |
| | Film- | film and | strength | | at break | |
| | breakage | conductive | (MPa) | | (%) | |
| No. | rate (%) | layer | MD | TD | MD | TD |
| Example 1 | 2 | 1.3 | 206 | 220 | 24 | 17 |
| Example 2 | 2 | 1.9 | 205 | 220 | 26 | 18 |
| Example 3 | 2 | 2.8 | 203 | 219 | 27 | 16 |
| Example 4 | 2 | 2.1 | 202 | 218 | 31 | 21 |
| Example 5 | 0 | 2.8 | 245 | 251 | 21 | 16 |
| Example 6 | 0 | 2.8 | 231 | 233 | 22 | 15 |
| Example 7 | 0 | 2.8 | 218 | 222 | 23 | 18 |
| Example 8 | 0 | 2.7 | 279 | 250 | 15 | 15 |
| Example 9 | 0 | 2.6 | 308 | 244 | 8 | 14 |
| Example 10 | 0 | 2.5 | 275 | 290 | 17 | 13 |
| Example 11 | 0 | 2.3 | 269 | 301 | 18 | 8 |
| Example 12 | 0 | 2.7 | 256 | 265 | 20 | 13 |
| Example 13 | 0 | 2.2 | 287 | 298 | 12 | 9 |
| Example 14 | 0 | 2.9 | 263 | 273 | 18 | 11 |
| Comparative | 8 | 0.8 | 145 | 181 | 38 | 21 |
| Example 1 | | | | | | |
| Comparative | 6 | 1.0 | 156 | 184 | 27 | 22 |
| Example 2 | | | | | | |
| Comparative | 4 | 0.9 | 165 | 191 | 36 | 20 |
| Example 3 | | | | | | |
| Comparative | 7 | 1.3 | 150 | 176 | 40 | 23 |
| Example 4 | | | | | | |
| Comparative | 5 | 1.3 | 161 | 185 | 36 | 22 |
| Example 5 | | | | | | |
| Comparative | 8 | 1.5 | 128 | 222 | 45 | 15 |
| Example 6 | | | | | | |
| Comparative | 2 | 1.3 | 208 | 155 | 22 | 32 |
| Example 7 | | | | | | |

As can be seen from the comparison of the test results:

(1) The free volume of the outer layer in the composite polyester film is mainly affected by the content of the oxygen-containing group-modified polyester in the outer layer, and by increasing the content of the oxygen-containing group-modified polyester, the free volume of the outer layer first increases and then decreases, which is mainly due to the fact that increasing the content of the oxygen-containing group-modified polyester can inhibit the crystallization of the polyester film, thus increasing the free volume; and based on the total mass of the outer layer, the mass percentage of the oxygen-containing group-modified polyester in the outer layer is optionally 5%-20%; preferably, the mass percentage of the oxygen-containing group-modified polyester in the outer layer is 15%.

(2) The tensile strength and elongation at break of the composite polyester film are mainly affected by the content of oxygen-containing group-modified polyester in the intermediate layer and the stretching ratio, and increasing the content of the oxygen-containing group-modified polyester in the intermediate layer in the mass percentage range of 0.5%-3% can improve the crystallization ability of the polyester, the force between the polyester macromolecules, and the plasticity, thereby enhancing the tensile strength of the polyester film. Preferably, the mass percentage of the oxygen-containing group-modified polyester in the intermediate layer is 1%. Due to the addition of the oxygen-containing group-modified polyester, the plasticity of the polyester polymer material can be improved, so that the stretching ratio during the processing can be increased, the stretching ratio is improved, the tensile strength of the polyester film is improved, and the elongation at break is reduced, taking both the tensile strength and the elongation at break into account, the preferred stretching ratio is 4:1 in the longitudinal direction and 3.5:1 in the transverse direction.

(3) The film breakage rate, the tensile strength and elongation at break in the preparation process of the composite current collector are mainly affected by the mechanical properties of polyester film, and the improvement of the mechanical properties of polyester film can enhance the mechanical properties of composite current collector and reduce the film breakage rate.

(4) The bonding strength between the polyester film of the composite current collector and the conductive layer is mainly affected by the size of the free volume of the surface layer of the polyester film, and increasing the free volume of the surface layer of the polyester film improves the bonding strength between the surface layer and the conductive layer.

The technical features of the above examples can be combined in any way, and in order to keep the description brief, possible combinations of each technical feature in the above examples are not described exhaustedly; however, as long as there is no contradiction in the combinations of these technical features, all of them should be considered to be within the disclosure scope of the specification.

The above examples express only several embodiments of the present application, which are described in a specific and detailed manner, but cannot be construed as a limitation of the scope of the present application. It should be noted that for a common skilled person in the field, several variations and improvements can be made without departing from the conception of the present application, which all fall within the protection scope of the present application. Therefore, the protection scope of the patent shall be defined by the claims, and the specification and the accompanying drawings may be used to illustrate the contents of the claims.

1. A composite polyester film, comprising: an intermediate layer, and a first outer layer and a second outer layer which are located on two opposite surfaces of the intermediate layer, respectively;
the intermediate layer comprises the following components by mass:
96.0-99.4 parts of a polyester and 0.5-3 parts of an oxygen-containing group-modified polyester;
the first outer layer comprises the following components by mass:
79.0-94.9 parts of the polyester and 5-20 parts of the oxygen-containing group-modified polyester; and
the second outer layer comprises the following components by mass:
79.0-94.9 parts of the polyester and 5-20 parts of the oxygen-containing group-modified polyester.

2. The composite polyester film according to claim 1, wherein the oxygen-containing group-modified polyester comprises one or more of a pentaerythritol-modified polyester, a glycerol-modified polyester, a poly(tetramethylene ether glycol)-modified polyester, a pyromellitic dianhydride-modified polyester, a 2,5-furandicarboxylic acid-modified polyester, an hydroxyl-terminated hyperbranched polyester, or a hexadecyl-terminated hyperbranched polyester.

3. The composite polyester film according to claim 1, wherein the oxygen-containing group-modified polyester has an intrinsic viscosity of 0.600-0.750 dL/g.

4. The composite polyester film according to claim 1, wherein the oxygen-containing group-modified polyester has a molecular weight distribution of 1.7-2.5.

5. The composite polyester film according to claim 1, wherein a modified unit in the oxygen-containing group-modified polyester has a molar proportion of 5%-15%.

6. The composite polyester film according to claim 1, wherein the polyester comprises one or more of polyethylene terephthalate and a derivative thereof, poly(ethylene-2,6-naphthalene dicarboxylate) and a derivative thereof, poly(butylene terephthalate) and a derivative thereof, poly(1,4-cyclohexylene dimethylene terephthalate) and a derivative thereof, poly(ethylene terephthalate-1,4-cyclohexylene dimethylene terephthalate), poly(propylene-2,6-naphthalene dicarboxylate) and a derivative thereof, poly(propylene terephthalate) and a derivative thereof, poly(butylene-2,6-naphthalene dicarboxylate) and a derivative thereof, poly(butylene-2,5-furandicarboxylate) and a derivative thereof, poly(butylene adipate-co-terephthalate) and a derivative thereof, and a polyarylester and a derivative thereof.

7. The composite polyester film according to claim 1, wherein the polyester has an intrinsic viscosity of 0.600-0.800 dL/g.

8. The composite polyester film according to claim 1, wherein the polyester has a molecular weight distribution of 1.7-2.5.

9. The composite polyester film according to claim 1, wherein the composite polyester film has one or more of the following features:
(1) the intermediate layer further comprises 0.1-1 parts by mass of an additive;
(2) the first outer layer further comprises 0.1-1 parts by mass of the additive; and
(3) the second outer layer further comprises 0.1-1 parts by mass of the additive.

10. The composite polyester film according to claim 9, wherein the additive comprises one or more of a slip agent, an antioxidant, an antistatic agent, or a nucleating agent.

11. The composite polyester film according to claim 9, wherein an average particle size of the additive is less than or equal to 30% of a thickness of a layer in which the additive is contained.

12. The composite polyester film according to claim 1, wherein a thickness ratio of the intermediate layer to the first outer layer to the second outer layer is (70-90):(5-15):(5-15).

13. A preparation method for the composite polyester film according to claim 1, which comprises:
subjecting 96.0-99.4 parts by mass of a polyester and 0.5-3 parts by mass of an oxygen-containing group-modified polyester to mixing and melting, extruding, and slicing to obtain an intermediate layer sheet;
subjecting 79.0-94.9 parts by mass of a polyester and 5-20 parts by mass of an oxygen-containing group-modified polyester to mixing and melting, extruding, and slicing to obtain a first outer layer sheet;
subjecting 79.0-94.9 parts by mass of a polyester and 5-20 parts by mass of an oxygen-containing group-modified polyester to mixing and melting, extruding, and slicing to obtain a second outer layer sheet;
subjecting the intermediate layer sheet, the first outer layer sheet, and the second outer layer sheet to melt co-extrusion to obtain a film sheet; and
stretching the film sheet.

14. The preparation method for the composite polyester film according to claim 13, wherein the stretching comprises transverse stretching and longitudinal stretching.

15. The preparation method for the composite polyester film according to claim 14,
wherein the transverse stretching has a ratio of (3-4):1;
the longitudinal stretching has a ratio of (3-5):1.

16. The preparation method for the composite polyester film according to claim 13, wherein after the stretching, the preparation method comprises subjecting the film sheet to a heat treatment.

17. A composite current collector, which comprises the composite polyester film according to claim 1 and a conductive layer located on at least one surface of the composite polyester film.

18. A battery, which comprises the composite current collector according to claim 17.

19. An electronic product, which comprises the battery according to claim 18.
